(19) United States
(12) Patent Application Publication
(10) Pub. No.: US 2015/0101494 A1
(43) Pub. Date: Apr. 16, 2015

(54) Portable Food Dehydrator

(71) Applicant: Micah Saccamanno, Bedford, NY (US)

(72) Inventor: Micah Saccamanno, Bedford, NY (US)

(21) Appl. No.: 14/055,834

(22) Filed: Oct. 16, 2013

(51) Int. Cl. A23L 3/40; F26B 9/00; F26B 3/04

(52) U.S. Cl. CPC A23L 3/40; F26B 3/04; F26B 9/003
USPC 99/483; 99/476; 34/218

(57) ABSTRACT

A portable food dehydrator having a warm vessel, a warm vessel lid having a guide opening and an assembly opening, a cover defining a cover cavity, the cover having openings and a chamber divider capable of sectioning the cover chamber into an inlet chamber and an outlet chamber, a fan assembly, a cool vessel, a sealing member, and a heating element.

### CROSS-REFERENCE TO RELATED APPLICATION

This application claims the benefit of priority to U.S. Provisional Application No. 61/715,221, filed on Oct. 17, 2012, which is incorporated herein by reference in its entirety.

### BACKGROUND

Dehydrators are used to reduce or remove water contained in food. Those who ascribe to Raw Vegan Culture desire to preserve the nutrients of the dehydrated food through restriction of temperature gain during the dehydration process, for example, to a preferred maximum of 118° Fahrenheit. Restaurants and food establishments lack the food requirements of the Raw Vegan Culture, while employment and travel environments present difficulties for those who desire dehydrated food that meets these standards. Current dehydrators must be brought to these environments and are restricted by their bulky size, power and wattage requirements, and heating capacity.

### SUMMARY OF THE INVENTION

The present disclosure pertains to a portable food dehydrator having a warm vessel defining a warm vessel cavity, a warm vessel lid having a guide opening and an assembly opening, the warm vessel lid capable of removeably engaging the warm vessel thereby defining a warm vessel chamber, a cover defining a cover cavity, the cover capable of removeably engaging the warm vessel lid thereby defining a cover chamber, the cover having openings and a chamber divider capable of sectioning the cover chamber into an inlet chamber and an outlet chamber, a fan assembly, a cool vessel, a sealing member having a support surface, and a heating element, where the assembly opening is capable of receiving the fan assembly, the warm vessel is capable of reducing heat transfer between the interior and exterior of the warm vessel, and the cool vessel is capable of reducing heat transfer between the interior and exterior of the warm vessel.

One aspect of the disclosure is a portable food dehydrator where the openings comprise inlet openings and outlet openings. In another aspect of the disclosure the sealing member is capable of engaging a warm vessel and a cool vessel. In another aspect of the disclosure the sealing member has an upper periphery, where the upper periphery extends from the support surface thereby defining an upper sealing cavity and the upper sealing cavity is capable of receiving the warm vessel. In another aspect of the disclosure the sealing member has a lower periphery, where the lower periphery extends from the support surface thereby defining a lower sealing cavity and the lower sealing cavity is capable of receiving the cool vessel.

In another aspect of the disclosure the portable food dehydrator has an air-guiding member having a passageway, where the guide opening is capable of receiving the air-guiding member. In another aspect of the disclosure the air-guiding member has a cylindrical periphery. In another aspect of the disclosure the air-guiding member is capable of reducing turbulent air flow into the warm vessel chamber. In another aspect of the disclosure the air-guiding member has a guide slit. In another aspect of the disclosure the guide slit is capable of reducing air turbulence within the warm vessel chamber. In another aspect of the disclosure the guide slit is capable of controlling the air to flow in a laminar orientation. In another aspect of the disclosure the guide slit is positioned within the periphery of the air-guiding member substantially parallel to the vertical axis of the air-guiding member. In another aspect of the disclosure the air-guiding member has a pressure member. In another aspect of the disclosure the pressure member is positioned at the end of the passageway. In another aspect of the disclosure the pressure member has a pressure opening.

In another aspect of the disclosure the portable food dehydrator has a temperature control device. In another aspect of the disclosure the portable food dehydrator has a humidity control device. In another aspect of the disclosure the portable food dehydrator has a switch capable of activating the dehydrator. In another aspect of the disclosure the portable food dehydrator has a handle. In another aspect of the disclosure the dehydrator is capable of heating the warm vessel to a desired temperature utilizing a DC power source.

With those and other objects, advantages and features on the invention that may become hereinafter apparent, the nature of the invention may be more clearly understood by reference to the following detailed description of the invention, the appended claims, and the drawings attached hereto.

### BRIEF DESCRIPTION OF THE DRAWINGS

The accompanying drawings, which are incorporated herein and form part of the specification, illustrate various embodiments of the present invention and together with the description, further serve to explain the principles of the invention and to enable a person skilled in the pertinent art to make and use the invention. In the drawings, like reference numbers indicate identical or functionally similar elements. A more complete appreciation of the invention and many of the attendant advantages thereof will be readily obtained as the same becomes better understood by reference to the following detailed description when considered in connection with the accompanying drawings, wherein:

FIG. 1 is a perspective view of a dehydrator according to an exemplary embodiment.

FIG. 2 is an exploded view of a dehydrator according to an exemplary embodiment.

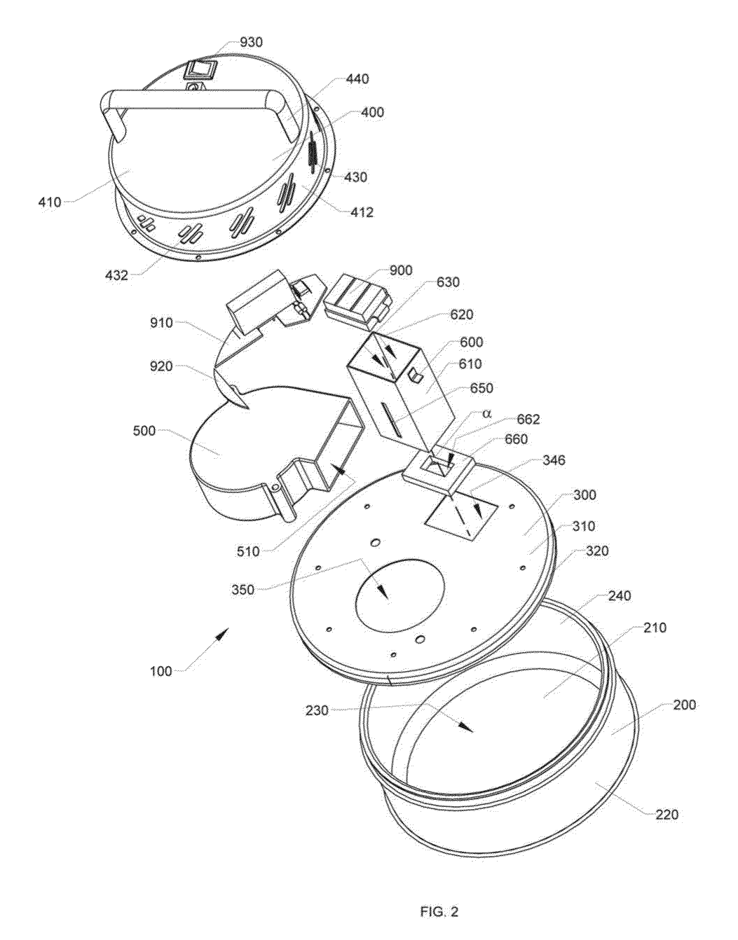

FIG. 3a is a perspective view of a cover according to an exemplary embodiment.

FIG. 3b is a bottom up view of a cover according to an exemplary embodiment.

FIG. 4 is a perspective view of a cover, vessel lid, and air-guide member according to an exemplary embodiment.

FIG. 5 is a cross-sectional exploded view of a dehydrator according to an exemplary embodiment.

FIG. 6 is a cross-sectional side view of a dehydrator according to an exemplary embodiment.

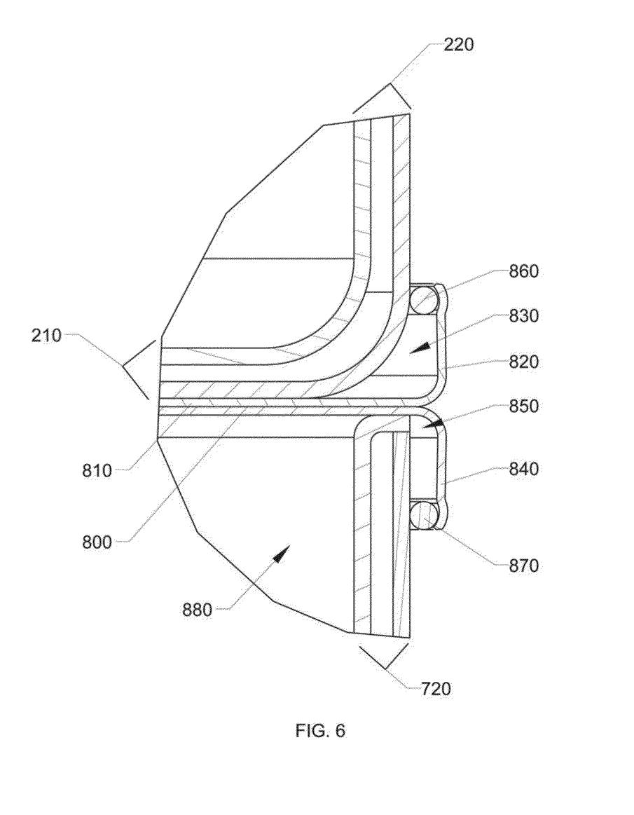

### DETAILED DESCRIPTION

In the following detailed description, reference is made to the accompanying drawings which form a part hereof and in which is shown by way of illustration specific embodiments in which the invention may be practiced. These embodiments are described in sufficient detail to enable those skilled in the art to practice the invention, and it is to be understood that other embodiments may be utilized and that structural or logical changes may be made without departing from the scope of the present invention. The following detailed description is, therefore, not to be taken in a limiting sense, and the scope of the present invention is defined by the appended claims.

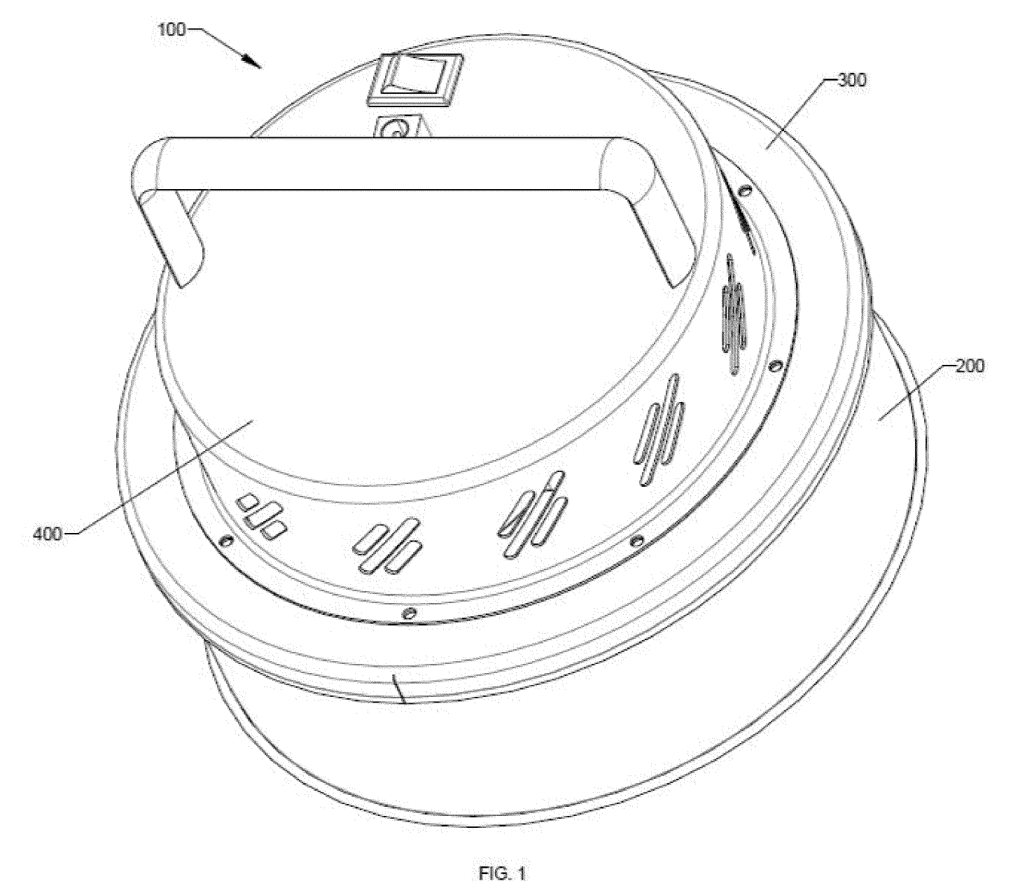

The present disclosure pertains to a portable food dehydrator 100 for dehydrating food. In one embodiment, as shown in FIGS. 1 & 2, the dehydrator 100 has at least one warm vessel 200 having a base 210 and a circular periphery 220 extending from the base 210 where said base 210 and circular periphery 220 define a warm cavity 230 for receiving warm food or food intended to be dehydrated, for example, meat, fruit, vegetables, or the like. The warm vessel 200 has an interior wall 240 for reducing heat transfer between the interior and exterior of the warm vessel 200. In one embodiment, the interior wall 240 is made of heat insulating material. In one embodiment, the interior wall 240 has an air barrier between an interior and exterior surface providing insulation to the warm vessel 200.

In one embodiment, the dehydrator 100 has a vessel lid 300 for containing air in a vessel 200, for example, a warm vessel 200 or cool vessel 700. The vessel lid 300 can have a top 310 and a circular periphery 320 extending from the top 310 where said top 310 and circular periphery 320 define a lid cavity 330. The vessel lid 300 can have a guide opening 346 and an assembly opening 350 located in the top 310, wherein the guide opening 346 receives the air-guide member and the assembly opening 350 receives the fan assembly 500.

The vessel lid 300 can removeably engage a vessel 200 thereby providing for a warm vessel chamber 250. For example, the interior surface of the periphery 320 engages the exterior surface of the warm vessel 200 thereby creating a seal and preventing air from flowing between the exterior and interior of the warm vessel 200. In one embodiment, the exterior diameter of the warm vessel 200 measured from exterior wall to exterior wall is less than the interior diameter of the vessel lid 300 allowing for the rim of the warm vessel 200 to seat within the lid cavity 330 when the warm vessel 200 engages the vessel lid 300. The vessel lid 300 can be made of any flexible material, for example, alloy, plastic, or the like. The vessel lid 300 can be made of heat insulating material, thereby decreasing heat transfer through the vessel lid 300.

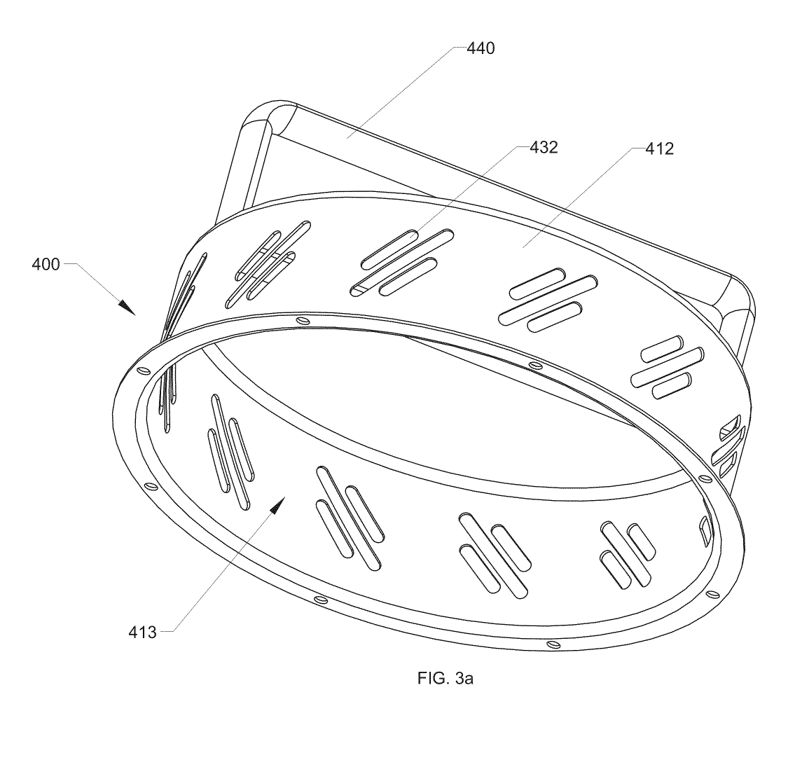

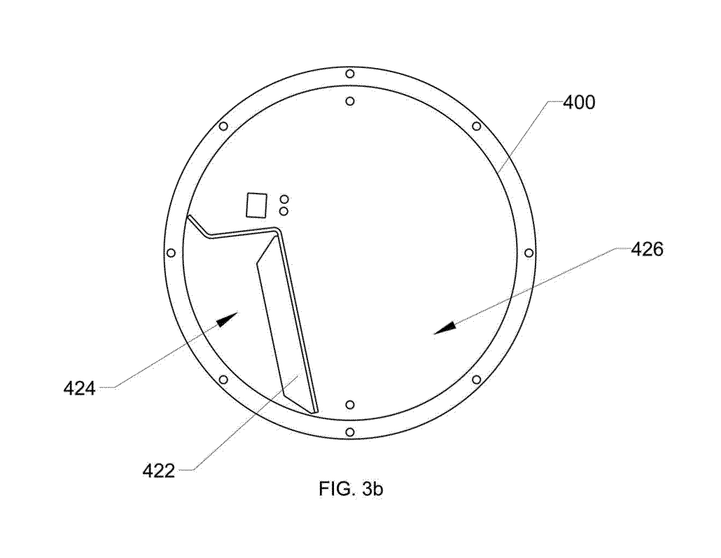

In one embodiment, the dehydrator 100 has a cover 400 allowing for inlet air to be separated from outlet air. The cover 400 has a top 410 and circular periphery 412 extending from the top thereby creating a cover cavity 413, as shown in FIG. 3a. The cover 400 can engage the vessel lid 300 thereby allowing for the vessel lid 300 to enclose the cover cavity 413 thereby creating a cover chamber. The fan assembly 500, heating element 900, temperature control device 910, humidity control device 920, and air-guiding member 600 can be located in the cover chamber. The cover chamber can receive air from the exterior of the dehydrator 100, receive air from the warm vessel chamber 250, and allow air to exit from the dehydrator 100. In one embodiment, the temperature control device 910 de-energizes the heating element upon the temperature reaching a desired level, for example, without limitation, between ambient temperature and 250° Fahrenheit, specifically 118° Fahrenheit or 140° Fahrenheit.

In one embodiment, as shown in FIG. 3b, the cover 400 has a chamber divider 422 for sectioning the cover chamber into an inlet chamber 424 for receiving air from the exterior of the dehydrator 100 through the inlet openings 430 and an outlet chamber 426 for receiving air from the warm vessel chamber 250 through the fan assembly 500.

In one embodiment, the cover 400 can have openings for allowing air to enter and exit the dehydrator 100. In one embodiment, an opening can be an inlet opening 430 for allowing air to pass from the exterior of the dehydrator 100, through the inlet opening 430, and into the cover chamber. In one embodiment, a plurality of the inlet openings 430 allow air to pass from the exterior of the dehydrator 100, through the inlet openings 430, and into the inlet chamber 424. In one embodiment, an opening can be an outlet opening 432 allowing for air to pass from the cover chamber, through the outlet opening 432, and to the exterior of the dehydrator 100. In one embodiment, a plurality of outlet openings 432 allow for air to pass from the outlet chamber 426, through the outlet openings 432, and to the exterior of the dehydrator 100. The dehydrator 100 can have any number or size of openings suitable for allowing air to enter and exit the dehydrator 100.

In one embodiment, the cover 400 can have a handle 440 allowing for the operator to remove the cover 400 from the dehydrator 100.

In one embodiment, the dehydrator 100 has a fan assembly 500 for generating air flow. The fan assembly 500 can engage the vessel lid 300. The fan assembly 500 has a motor with driven output shaft engaged thereto, an impeller engaging the output shaft, an outflow aperture 510, and an inflow aperture extending through the vessel lid 300. Therefore, when the motor is energized, the output shaft is rotated thereby rotating the impeller and generating air flow.

In one embodiment, the dehydrator 100 has an air-guiding member 600 for allowing air to flow from the inlet chamber 424 into the warm vessel chamber 250 in a manner that reduces turbulent air flow. The air-guiding member 600 has a cylindrical periphery 610 providing for a passageway 620 that allows air to flow from the inlet chamber 424 into the warm vessel chamber 250. The air-guiding member 600 can have a guide inlet 630 for allowing air to enter the passageway 620 from the inlet chamber 424 and a guide outlet 640 for allowing air to exit the passageway 620 and into the warm vessel chamber 250. In one embodiment, the air-guiding member 600 engages the vessel lid 300.

In one embodiment, the air-guiding member 600 has at least one guide slit 650 that reduces air turbulence within the warm vessel chamber 250, thereby reducing the mixture of flavors of a plurality of food items within the warm vessel 200. In one embodiment, the guide slit 650 allows the air flowing into the warm vessel 200 through the guide slit 650 to flow in a laminar orientation thereby reducing air turbulence within the warm vessel 200. The guide slit 650 can be positioned within the periphery of the air-guiding member 600 oriented in a manner substantially parallel to axis cc of the air-guiding member 600. The air-guiding member 600 can have a plurality of guide slits 650 of any suitable size or dimension.

In one embodiment, the air-guiding member 600 has a pressure member 660 for increasing the pressure or amount of air flow through the guide slit 650. The pressure member 660 can be any object that decreases the amount of air flowing through the guide outlet 640, thereby increasing the pressure of air flowing through the guide slit 650. In one embodiment, the pressure member 660 is in the shape of a disc appropriately sized to increase the amount of air flowing through the guide slit 650 to a desired amount. While the pressure member 660 can be positioned at any cross-sectional location along axis cc of the passageway 620, the pressure member 660 is preferably positioned at the end of the passageway 620 or within the guide outlet 640. In one embodiment, the pressure member 660 has at least one pressure opening 662 for decreasing the amount of air flowing through the guide slit 650. In one embodiment, the pressure opening 662 decreases the amount of air turbulence inside the warm vessel chamber 250. The amount of air turbulence inside the warm vessel chamber 250 can be altered by the cubic feet per minute of the fan, shape of guide slit 650 (e.g. tapered, trapezoidal, triangular, or the like), length or width of the guide slit 650, size of the pressure opening 662, quantity of pressure openings 662, length of the air-guide member 600, height of the pressure member 660, radius of the pressure opening 662, exterior radius of the pressure member 660, or the like. For example, a pressure member 660 with four pressure openings 662 will allow for a decreased amount of air flowing through the guide slit 650 than a pressure member 660 with two pressure openings 662.

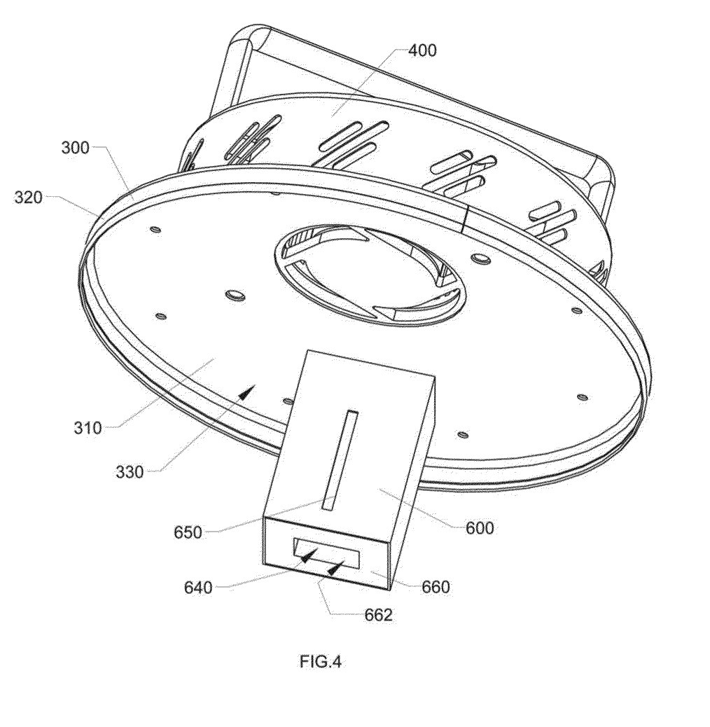

In one embodiment, as shown in FIG. 4, the dehydrator 100 has at least one cool vessel 700 having a base 710 and a circular periphery 720 extending from the base where said base 710 and circular periphery 720 define a cool cavity for receiving cool food or food intended to be maintained at a cool temperature, for example, meat, fruit, vegetables, liquid, or the like. The cool vessel 700 has an interior wall for reducing heat transfer between the interior and exterior of the cool vessel 700. In one embodiment, the interior wall is made of heat insulating material, for example, an air barrier between an interior and exterior surface providing insulation to the warm vessel 200.

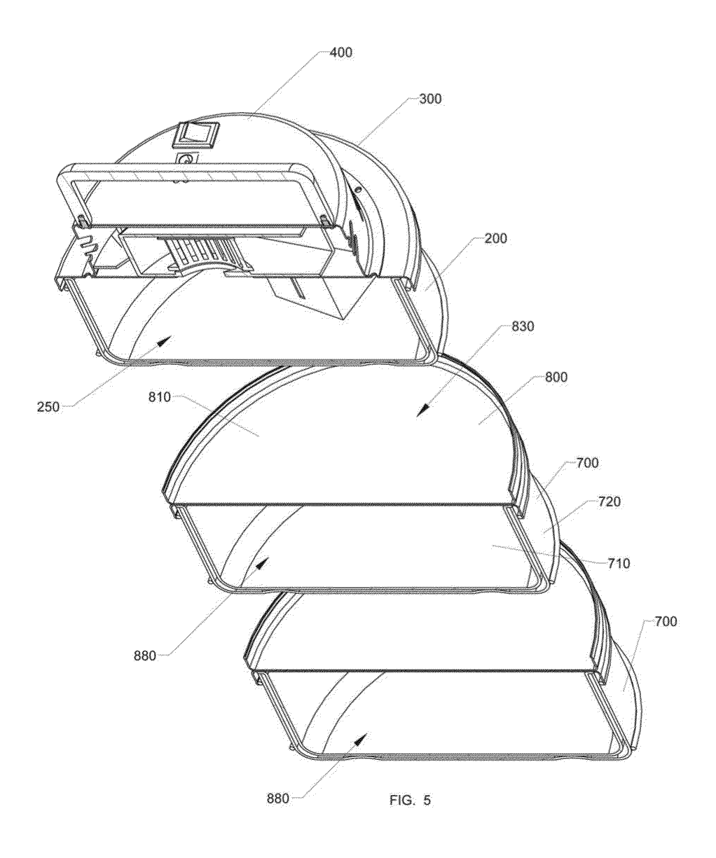

In one embodiment, the dehydrator 100 has a plurality of vessels, for example, a combination of warm vessels 200 and cool vessels 700. In one embodiment, as shown in FIG. 5, the dehydrator 100 has a sealing member 800 for engaging two vessels, for example, without limitation, a ware vessel 200 and a cool vessel 700. In one embodiment, the sealing member 800 can create a seal on a vessels. The sealing member 800 can have a support surface 810, an upper periphery 820 extending from the support surface 810 thereby creating an upper sealing cavity 830, and a lower periphery 840 extending in an opposite direction from the upper periphery 820 from the support surface 810 thereby creating a lower sealing cavity 850. The sealing member 800 can be made of any elastomeric material, for example, without limitation, natural rubbers, polyisoprene, styrene butadiene rubber, chloroprene rubber, polybutadiene, nitrile rubber, butyl rubber, ethylene propylene rubber, ethylene propylene diene monomer, chlorosulfonated polyethylene, polysulfide rubber, polyurethane, silicones, or the like. The support surface 810 can be made of heat insulating material thereby decreasing heat transfer from one vessel to another vessel.

The upper sealing cavity 830 can receive the bottom of a vessel wherein the interior of the upper periphery 820 engages the exterior of the periphery of the vessel thereby securing said sealing member 800 to the dehydrator 100 and/or reducing heat transfer from the interior of the vessel to the exterior or the vessel. In one embodiment, the vessel can have a lower ridge 860 or a protrusion running along the exterior of the vessel substantially proximate to the base of the periphery. The interior of the upper periphery 820 can engage the lower ridge 860 of the periphery thereby securing said sealing member 800 to the dehydrator 100 and/or reducing heat transfer from the interior of the vessel to the exterior or the vessel.

The lower sealing cavity 850 can receive the top of the periphery of a vessel wherein the interior of the lower periphery 840 engages the exterior of the periphery of the vessel thereby providing for a cool vessel chamber 880 preventing air from flowing between the exterior and interior of the vessel. In one embodiment, the vessel can have an upper ridge 870 or a protrusion running along the exterior of the vessel substantially proximate to the top of the periphery. The interior of the lower periphery 840 can engage the upper ridge 870 of the periphery of the vessel thereby preventing air from flowing between the exterior and interior of the vessel. In one embodiment, the interior of the periphery of the vessel lid 300 engages the upper ridge 870 thereby creating a seal and preventing air from flowing between the exterior and interior of the vessel. In one embodiment, the interior of the vessel lid 300 can engage the upper ridge 870 of the periphery of the vessel thereby preventing air from flowing between the exterior and interior of the vessel.

In one embodiment, the dehydrator 100 has a heating element 900 for heating air that flows between the cover chamber and the warm vessel chamber 250. The heating element 900 can be, for example, of a resistant type as a wire, a plate, or the like. The heating element 900 can engage the air-guiding member 600 proximate to the guide inlet 630 where the heating element 900 is located in the cover chamber.

In one embodiment, the dehydrator 100 can have a temperature control device 910 for controlling the temperature of the warm vessel chamber 250. The temperature control device 910 can be of a preferred specification wherein said specification is associated with a set temperature, for example, without limitation, 118° Fahrenheit. The temperature control device 910 controls the temperature of the warm vessel chamber 250 by providing for the dehydrator 100 to be stopped and started depending on the temperature in the warm vessel chamber 250. For example, upon measuring a temperature value greater than the set temperature, the dehydrator 100 is automatically stopped or upon measuring a temperature value below the set temperature the dehydrator 100 is started or resumed. The temperature control device 910 can be a thermistor, bimettal, or the like.

In one embodiment, the dehydrator 100 can have a humidity control device 920 for controlling the humidity in the warm vessel chamber 250. The humidity control device 920 can be of a preferred specification wherein said specification is associated with a set humidity. The humidity control device 920 controls the humidity in the warm vessel chamber 250 by providing for the dehydrator 100 to be stopped and started depending on the humidity in the warm vessel chamber 250. For example, upon measuring a humidity value greater than the set humidity, the dehydrator 100 is automatically stopped or upon measuring a humidity value below the set humidity the dehydrator 100 is started or resumed. The humidity control device 920 can be a wire copper probe or the like.

In one embodiment, the dehydrator 100 has a switch 930 for activating the dehydrator 100. The switch 930 can be any switch 930 suitable to activate the dehydrator 100, for example, a single-contact switch where the switch 930 remains closed until it is moved back to its center position. When the switch 930 is in its closed position, power is supplied through circuitry to power the motor, heating element 900, temperature control device 910, humidity control device 920, or any combination thereof. The dehydrator 100 can be connected to an electrical source, for example, an AC or DC source. The dehydrator 100 is capable of heating the warm vessel to a desired temperature, including those temperatures described herein, utilizing an electrical source.

During operation, the method of dehydrating food can include, without limitation, the steps of the warm cavity 230 receiving food, engaging the vessel lid 300 to the warm vessel 200, activating the switch 930, energizing the motor, rotating the impeller, drawing air from the exterior of the dehydrator 100 through the inlet openings 430, into the inlet chamber 424, through the heat element 900, through the guide inlet 630, into the passageway 620, through the guide slits 650, through the guide outlet 640, into the warm vessel chamber 250, through the assembly opening 350, into the fan assembly 500, through the fan outlet 510, into the outlet chamber 426, through the outlet openings 432, and into the exterior of the dehydrator 100. In one embodiment, the method of dehydrating food can further include the step of the cool vessel cavity receiving food.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

The foregoing has described the principles, embodiments, and modes of operation of the present invention. However, the invention should not be construed as being limited to the particular embodiments described above, as they should be regarded as being illustrative and not as restrictive. It should be appreciated that variations may be made in those embodiments by those skilled in the art without departing from the scope of the present invention.

Modifications and variations of the present invention are possible in light of the above teachings. It is therefore to be understood that the invention may be practiced otherwise than as specifically described herein.

What is claimed is:

1. A portable food dehydrator comprising:
a warm vessel defining a warm vessel cavity,
a warm vessel lid having a guide opening and an assembly opening, the warm vessel lid capable of removeably engaging the warm vessel thereby defining a warm vessel chamber,
a cover defining a cover cavity, the cover capable of removeably engaging the warm vessel lid thereby defining a cover chamber, the cover having openings and a chamber divider capable of sectioning the cover chamber into an inlet chamber and an outlet chamber,
a fan assembly,
a cool vessel,
a sealing member having a support surface, and
a heating element,
wherein the assembly opening is capable of receiving the fan assembly, the warm vessel is capable of reducing heat transfer between the interior and exterior of the warm vessel, and the cool vessel is capable of reducing heat transfer between the interior and exterior of the warm vessel

2. The portable food dehydrator of claim 1 wherein the openings comprise inlet openings and outlet openings.

3. The portable food dehydrator of claim 1 wherein the sealing member is capable of engaging a warm vessel and a cool vessel.

4. The portable food dehydrator of claim 1 wherein the sealing member further comprises an upper periphery, wherein the upper periphery extends from the support surface thereby defining an upper sealing cavity and the upper sealing cavity is capable of receiving the warm vessel.

5. The portable food dehydrator of claim 1 wherein the sealing member further comprises a lower periphery, wherein the lower periphery extends from the support surface thereby defining a lower sealing cavity and the lower sealing cavity is capable of receiving the cool vessel.

6. The portable food dehydrator of claim 1 further comprising an air-guiding member having a passageway, wherein the guide opening is capable of receiving the air-guiding member.

7. The portable food dehydrator of claim 6 wherein the air-guiding member comprises a cylindrical periphery.

8. The portable food dehydrator of claim 6 wherein the air-guiding member is capable of reducing turbulent air flow into the warm vessel chamber.

9. The portable food dehydrator of claim 6 wherein the air-guiding member comprises a guide slit.

10. The portable food dehydrator of claim 9 wherein the guide slit is capable of reducing air turbulence within the warm vessel chamber.

11. The portable food dehydrator of claim 9 wherein the guide slit is capable of controlling the air to flow in a laminar orientation.

12. The portable food dehydrator of claim 9 wherein the guide slit is positioned within the periphery of the air-guiding member substantially parallel to the vertical axis of the air-guiding member.

13. The portable food dehydrator of claim 9 wherein the air-guiding member comprises a pressure member.

14. The portable food dehydrator of claim 13 wherein the pressure member is positioned at the end of the passageway.

15. The portable food dehydrator of claim 13 wherein the pressure member comprises a pressure opening.

16. The portable food dehydrator of claim 1 further comprising a temperature control device.

17. The portable food dehydrator of claim 1 further comprising a humidity control device.

18. The portable food dehydrator of claim 1 further comprising a switch capable of activating the dehydrator.

19. The portable food dehydrator of claim 1 further comprising a handle.

20. The portable food dehydrator of claim 1 wherein the dehydrator is capable of heating the warm vessel to a desired temperature utilizing a DC power source.
